(19) United States
(12) Patent Application Publication
(10) Pub. No.: US 2022/0159797 A1
(43) Pub. Date: May 19, 2022

(54) MICROWAVE HEATING METHOD AND MICROWAVE HEATING DEVICE

(71) Applicant: Industrial Technology Research Institute, Hsinchu (TW)

(72) Inventors: Chia-Ching Huang, Changhua County (TW); Yueh-Lin Tsai, Yunlin County (TW); Wei-Ji Chen, Tainan City (TW); Joseph Poujiong Wang, New Taipei City (TW)

(73) Assignee: Industrial Technology Research Institute, Hsinchu (TW)

(21) Appl. No.: 17/134,156

(22) Filed: Dec. 24, 2020

(30) Foreign Application Priority Data
Nov. 18, 2020 (TW) 109140269

(51) Int. Cl. H05B 6/68; H05B 6/64; H05B 6/72

(52) U.S. Cl. CPC H05B 6/68; H05B 6/72; H05B 6/6402

(57) ABSTRACT

A microwave heating method includes following steps: setting multiple microwave heating modes and their corresponding arrangements of resonator; selecting one of the microwave heating modes according to a heating condition; and, disposing an object to be heated and at least one resonator into a heating chamber, and providing a microwave signal to heat the object to heated, wherein a resonance frequency of the at least one resonator is corresponding to a frequency of the microwave signal, and the at least one resonator is arranged in the arrangement corresponding to the selected microwave heating mode. A microwave heating device suitable for the above microwave heating method is also proposed.

### CROSS-REFERENCE TO RELATED APPLICATION

The present disclosure claims the priority benefit of Taiwan application serial no. 109140269, filed on Nov. 18, 2020. The entirety of the above-mentioned patent application is hereby incorporated by reference herein and made a part of this specification.

### BACKGROUND

### Technical Field

The present disclosure relates to a heating method and a heating device, and particularly relates to a microwave heating method and a microwave heating device.

### Description of Related Art

The microwave heating technology is widely used in daily life and industry to heat objects to be heated using microwave in food preparation, meat thawing, wood drying, rubber vulcanization, and even in semiconductor processes.

The current microwave heating technology utilizes, for example, a mechanical turntable to hold the object to be heated or a microwave mixer in the heating chamber to increase the heating uniformity, but the effect is limited. In addition, there are also known technologies that use multi-port phased array microwave sources to improve heating uniformity. However, the production and maintenance costs of such microwave heating devices are high.

On the other hand, the current microwave heating device is not flexible enough to adjust the heating state, and cannot effectively adapt to different objects to be heated and heating conditions. Therefore, an improvement in microwave heating technology is needed.

### SUMMARY

The disclosure provides a microwave heating method and a microwave heating device, which can improve the heating uniformity for objects to be heated.

The present disclosure provides a microwave heating method and a microwave heating device, which can be adapted to different objects to be heated and heating conditions, and provide corresponding microwave heating modes.

In an embodiment of the present disclosure, the microwave heating method comprises: setting a plurality of microwave heating modes and their corresponding resonator layouts; selecting a microwave heating mode according to a heating condition; and, placing an object to be heated together with at least one resonator in a heating chamber, and providing a microwave signal in the heating chamber to heat the object to be heated, wherein a resonance frequency of the at least one resonator responds to a frequency of the microwave signal, and the at least one resonator is arranged as the resonator layout corresponding to the selected microwave heating mode.

In an embodiment of the present disclosure, the microwave heating device includes: a heating chamber; a microwave transmitter for providing a microwave signal to the heating chamber; a memory circuit, storing multiple microwave heating modes and their corresponding resonator layouts; at least one resonator, placed in the heating chamber according to the resonator layout corresponding to each microwave heating mode, and a resonance frequency of the at least one resonator responds to a frequency of the microwave signal; and, a processor, electrically connected to the memory circuit and the microwave transmitter, wherein the processor selects a microwave heating mode according to an input heating condition and control the microwave transmitter according to the microwave heating mode, while heating an object to be heated in the corresponding resonator layout.

Based on the above, the present disclosure selectively changes the heating power distribution in the heating chamber by placing a resonator in the heating chamber that responds to the microwave frequency to enhance the electromagnetic energy around the resonator. By doing so, the heating uniformity for the object to be heated can be improved, or the heating power in a specific area can be increased as needed to achieve a concentrated heating effect. In addition, the microwave heating mode and its corresponding resonator layout can be selected according to the heating condition, so that the microwave heating mode can be adapted to different objects to be heated and heating conditions.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a three-dimensional schematic diagram of a microwave heating device according to an embodiment of the present disclosure.

FIGS. 1B and 1C are cross-sectional schematic diagrams of the microwave heating device of FIG. 1A along two orthogonal planes, respectively.

FIG. 1D shows the object to be heated and the resonator placed in the heating chamber.

FIG. 2 shows the measurements of power loss density on the surface and the central cross section of the object to be heated with and without the resonator in the heating chamber using microwave signal at 2.4 GHz and 3.6 GHz, respectively.

FIG. 3 is a block diagram of a microwave heating device according to an embodiment of the present disclosure.

FIG. 4 is a flowchart of a microwave heating method corresponding to the microwave heating device of FIG. 3.

FIG. 5 shows the measurements of the power loss density of the central cross section of the object to be heated with and without the resonator in the heating chamber using a microwave signal with a frequency of 2.4 GHz, respectively, according to an embodiment of the present disclosure.

FIG. 6 shows the temperature distribution after 500 seconds of heating with and without resonator for the embodiment in FIG. 5.

FIG. 7 shows the measurements of the power loss density of the central cross section of the object to be heated with and without the resonator in the heating chamber using a microwave signal with a frequency of 2.4 GHz, respectively, according to an embodiment of the present disclosure.

FIG. 8 shows the temperature distribution after 500 seconds of heating with and without resonator for the embodiment in FIG. 7.

FIG. 9 shows the measurements of the power loss density of the central cross section of the object to be heated with and without the resonator in the heating chamber using a microwave signal with a frequency of 2.4 GHz, respectively, according to an embodiment of the present disclosure.

FIG. 10 shows the temperature distribution after 500 seconds of heating with and without resonator for the embodiment in FIG. 9.

FIG. 11 shows the measurements of the power loss density of the central cross section of the object to be heated with and without the resonator in the heating chamber using a microwave signal with a frequency of 3.6 GHz, respectively, according to an embodiment of the present disclosure.

FIG. 12 shows the temperature distribution after 500 seconds of heating with and without resonator for the embodiment in FIG. 11.

FIG. 13 shows the measurements of the power loss density of the central cross section of the object to be heated with and without the resonator in the heating chamber using a microwave signal with a frequency of 3.6 GHz, respectively, according to an embodiment of the present disclosure.

FIG. 14 shows the temperature distribution after 500 seconds of heating with and without resonator for the embodiment in FIG. 13.

FIG. 15 shows the measurements of the power loss density of the central cross section of the object to be heated with and without the resonator in the heating chamber using a microwave signal with a frequency of 2.4 GHz, respectively, according to an embodiment of the present disclosure.

FIG. 16 shows the temperature distribution after 500 seconds of heating with and without resonator for the embodiment in FIG. 15.

### DESCRIPTION OF THE EMBODIMENTS

In the related technical field of the present disclosure, the resonator can be a waveguide structure, and the frequency of the resonant mode is inversely proportional to the square root of the dielectric constant of its material. Under the same resonance frequency, choosing a material with a high dielectric constant can reduce the size of the resonator; in addition, the larger the size of the resonator, the lower the frequency of the resonance mode. The resonator used in the present disclosure can be made of high dielectric material or metal, and is set up to form resonance conditions with microwave signal in the heating chamber to enhance the electromagnetic energy around the resonator, thereby changing the heating power distribution in the heating chamber.

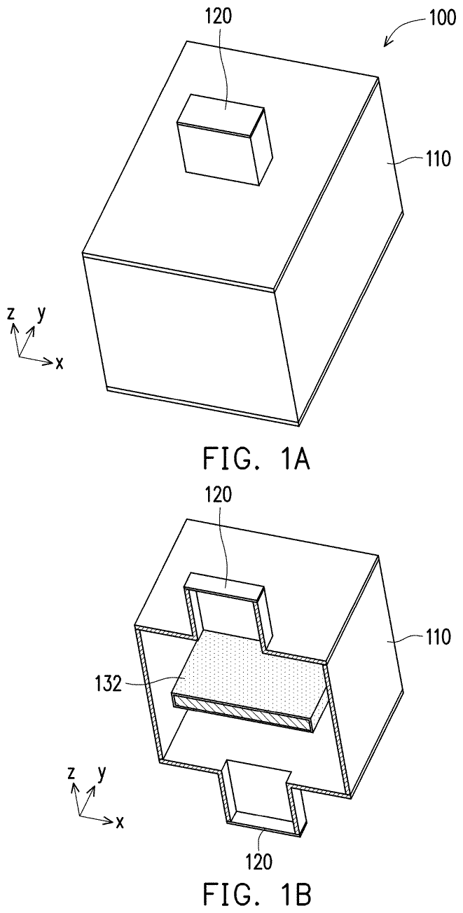

FIG. 1A is a three-dimensional schematic diagram of a microwave heating device according to an embodiment of the present disclosure. FIGS. 1B and 1C are cross-sectional schematic diagrams of the microwave heating device of FIG. 1A along two orthogonal planes, respectively. As shown in FIGS. 1A to 1C, the microwave heating device 100 includes a heating chamber 110, and a microwave transmitter 120 for providing microwave signal to the heating chamber 110. The present embodiment is provided with two microwave transmitters 120, which are arranged on opposite sides of the heating chamber 110, such as upper and lower sides, where the microwave transmitter 120 can transmit microwave signals with frequencies between 2 GHz and 4 GHz to the heating chamber 110 to heat the object to be heated 130 in the heating chamber 110 as shown in FIG. 1D. The number of the aforementioned microwave transmitters 120 is not limited to two, nor is it limited to being placed on the upper and lower sides of the heating chamber 110. One of ordinary skill in the art can adjust the number and position of the microwave transmitters 120 according to practical requirements. In addition, in the present embodiment, the object to be heated 130 can be carried by, for example, the carrier 132, so as to fix the object to be heated 130 in a specific position in the heating chamber 110.

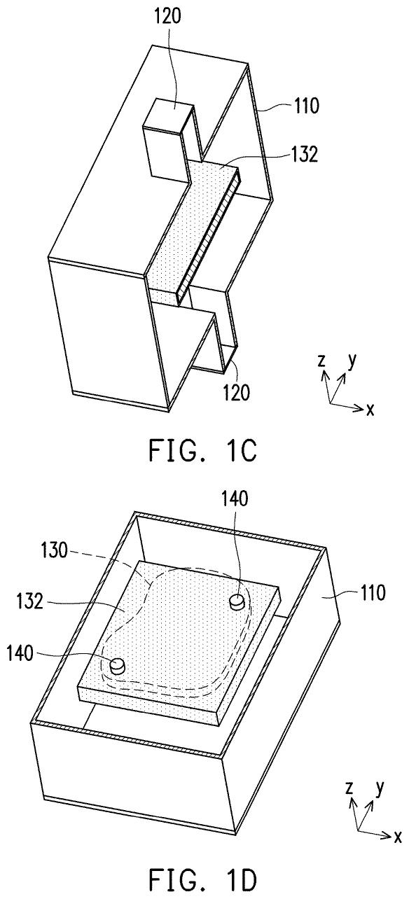

FIG. 1D shows the object to be heated 130 and the resonators 140 placed in the heating chamber 110. According to the configuration of the heating chamber 110 and the microwave transmitters 120, the resonators 140 are placed at appropriate positions in the heating chamber 110 to form a resonant condition between the resonators 140 and the microwaves transmitted by the microwave transmitters 120 in order to change the heating power distribution in the heating chamber 110. In the present embodiment, two resonators 140 are placed at opposite corners of the object to be heated 130. For example, the resonators 140 are fixed on the carrier 132 corresponding to the corners of the object to be heated 130. A comparison of the power loss density (PLD) distribution in the heating chamber 110 can be obtained as shown in FIG. 2.

FIG. 2 shows the measurements of power loss density on the surface and the central cross section of the object to be heated with and without the resonators 140 in the heating chamber 110 using microwave signal at 2.4 GHz and 3.6 GHz, respectively. From FIG. 2, it can be seen that when two resonators 140 are placed at opposite corners of the object to be heated 130, the heating power around the resonators 140 increases, which enhances the heating effect of the object to be heated 130 around the resonators 140 and thereby improves the heating uniformity of the microwave heating device 100 to the object to be heated 130.

In addition to the foregoing embodiments, the present disclosure can also use resonator(s) to increase the heating power of a specific area. For example, the resonator(s) can be placed on a position with a higher heating power as required to further enhance the heating power and obtain the effect of concentrated heating. This concentrated heating scheme will be demonstrated in the following embodiments.

Based on the aforementioned configuration of selectively changing the heating power distribution in the heating chamber by configuring the resonators, the present disclosure can further specify the microwave heating mode and its corresponding resonator(s) layout according to the heating condition, to provide corresponding technical solutions for different objects to be heated and heating conditions.

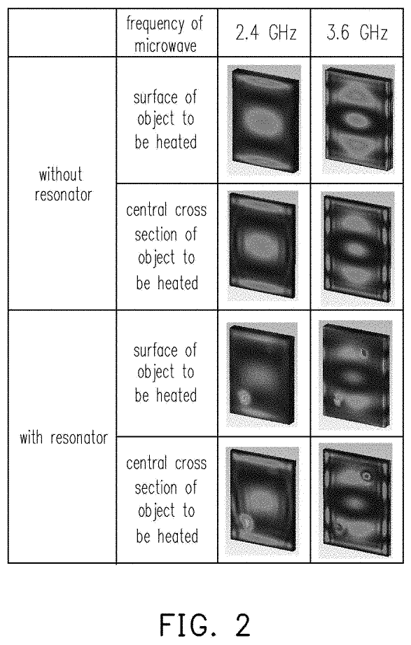

FIG. 3 is a block diagram of a microwave heating device according to an embodiment of the present disclosure. In the present embodiment, the memory circuit 310 stores multiple microwave heating modes and their corresponding resonator(s) layouts. The processor 320 is electrically connected to the memory circuit 310 and the microwave transmitter 330 to select the microwave heating mode stored in the memory circuit 310 according to external heating conditions, and control the microwave transmitter 330 to transmit the microwave signal into the heating chamber according to the selected microwave heating mode, so as to heat the object to be heated under the corresponding resonator(s) layout. The resonator(s) is placed in the heating chamber according to the resonator(s) layout corresponding to each microwave heating mode, and the resonance frequency of the used resonator(s) can respond to the frequency of the microwave signal transmitted by the microwave transmitter 330 to create resonance conditions with the microwave signal.

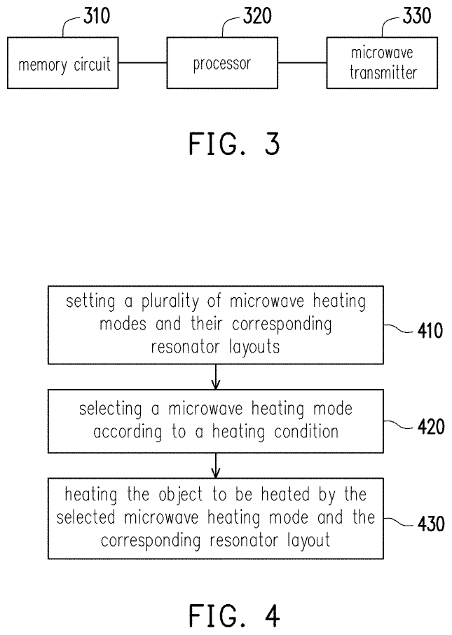

FIG. 4 is a flowchart of the microwave heating method corresponding to the microwave heating device described above. The microwave heating method first sets up a plurality of microwave heating modes and their corresponding resonator(s) layouts (step 410), and this data may be stored, for example, in the memory circuit 310 of FIG. 3. The corresponding resonator(s) layouts for the different microwave heating modes can be determined by, for example, obtaining the power loss density in the heating chamber when the heating object is heated by microwave signal without a resonator, and then determining position of the resonator(s) based on the power loss density in the heating chamber.

Specifically, depending on the selected heating mode, the resonator(s) can be placed at a position where the power loss density is relatively high or low depending on the power loss density in the heating chamber. The number of resonators can be one or more. Also, if the carrier 132 is used to carry the object to be heated 130 as shown in FIG. 1D, the resonators 140 can be attached or fabricated at a specific location on the carrier 132. In addition, by adjusting the position of the carrier 132 within the heating chamber 110, such as the upper, middle, and lower levels, the object to be heated 130 can also be placed under different heating power distributions. If there are multiple resonators, it is also possible to consider arranging the resonators in a specific pattern. For example, the resonators 140 can be concentrated in the center region of the carrier 132, or the resonators 140 can be dispersed on the carrier 132.

Next, as shown in step 420, the microwave heating mode is selected according to the heating condition. The heating condition is, for example, the weight of the object to be heated, the material of the object to be heated, the desired state of the object to be heated after being heated, or other known conditions from external users or external data sources. These conditions can be considered individually or comprehensively.

Then, as shown in step 430, the object is heated by the selected microwave heating mode and its corresponding resonator(s) layout. Specifically, the object to be heated and the resonator(s) are placed together in the heating chamber, where the resonator(s) is arranged as the resonator(s) layout corresponding to the selected microwave heating mode. And, the microwave signal is provided in the heating chamber to heat the object to be heated. In actual operation, an electronic menu may be displayed to instruct the user where the object to be heated should be placed when the processor 320 of the microwave heating device as shown in FIG. 3 determines the microwave heating mode. Alternatively, if a carrier configured with resonator(s) is selected to carry the heating object, the processor 320 can display an electronic menu to instruct the user which carrier should be used, determine the corresponding microwave frequency, and control the microwave transmitter 330 to transmit the microwave signal into the heating chamber. Here, the microwave frequency used in different microwave heating modes may be different, and the resonance frequency of the used resonator(s) responds to the frequency of the microwave signal to form a resonance condition. The material of the resonator(s) may be a dielectric material or a metal material. The resonator(s) can be placed as a separate structure in the heating chamber or outside the object to be heated. Alternatively, the resonator(s) can be attached or fabricated on a carrier that may be required to carry the object to be heated.

The following embodiments shows examples of heating foodstuffs (e.g., meat) by microwave heating devices to further illustrate the technical solutions of the present disclosure.

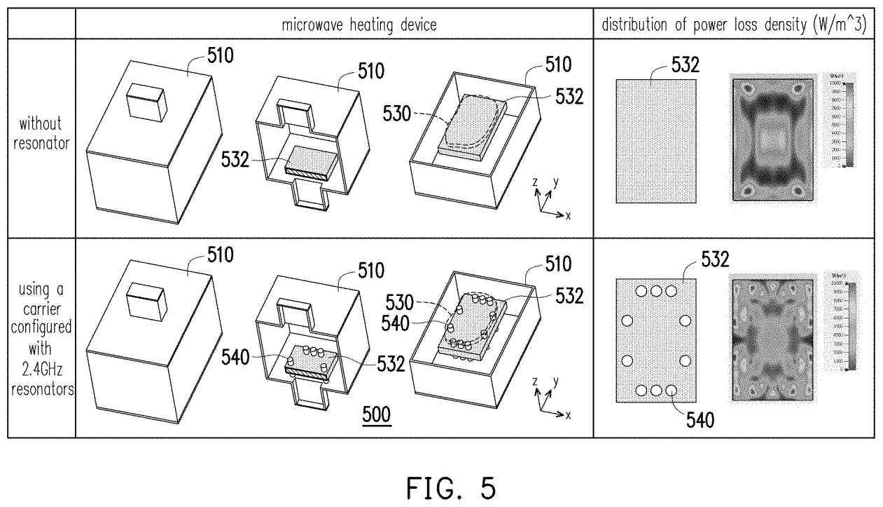

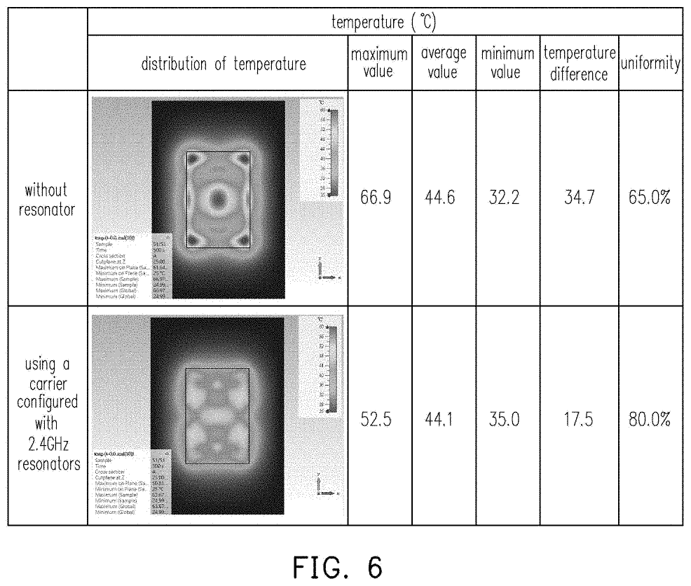

FIG. 5 shows the measurements of the power loss density of the central cross section of the object to be heated 530 with and without the resonators 540 in the heating chamber 510 using a microwave signal with a frequency of 2.4 GHz, respectively, according to an embodiment of the present disclosure. In the present embodiment, the user inputs a heating condition to heat meat weighing less than 200 grams (i.e., the object to be heated 530), and the corresponding electronic menu indicates the selection of the lower level of the heating chamber 510 as shown in FIG. 5, and instructs the use of the corresponding carrier 532. Herein, the frequency of microwave signal is 2.4 GHz, and the corresponding carrier 532 is equipped with the resonators 540 having resonance frequency of 2.4 GHz, wherein the resonators 540 are placed in an area where the power loss density is relatively weak when the object 530 is heated by microwave signal without the resonators 540. For example, the resonators 540 is placed in an area where the power loss density is about 1/10˜ 1/100 of the strongest point. FIG. 6 shows the temperature distribution after 500 seconds of heating with and without resonators for the embodiment in FIG. 5. As shown in FIG. 6, compared to the case without the resonators 540, the temperature difference of microwave heating with the resonators 540 decreases by 17.2 degrees, and the temperature uniformity increases by 15.0%. Obviously, the resonators 540 of the present embodiment improve the heating uniformity of the microwave heating device 500 in heating the object to be heated 530.

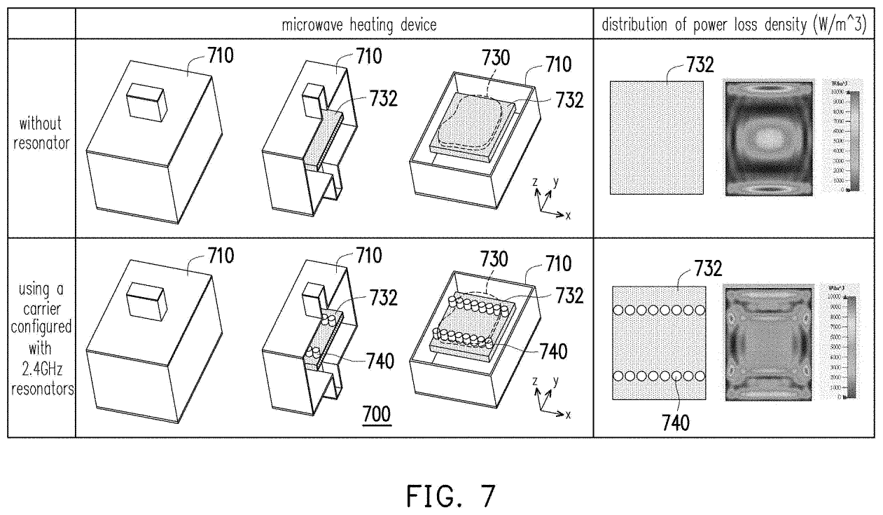

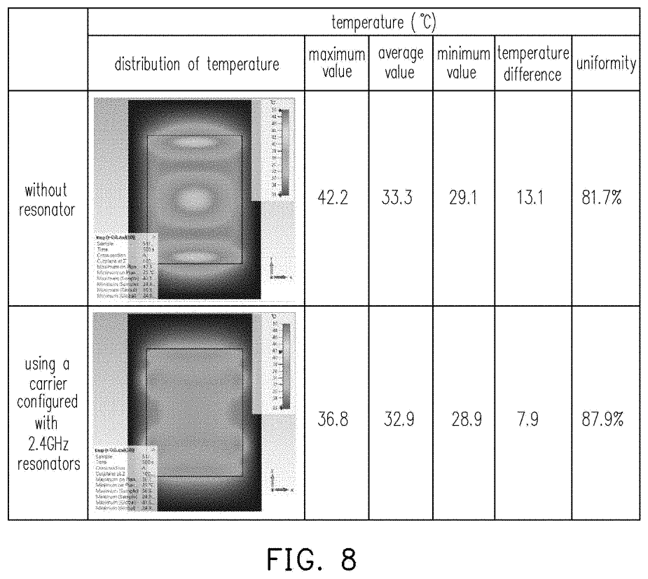

FIG. 7 shows the measurements of the power loss density of the central cross section of the object to be heated 730 with and without the resonators 740 in the heating chamber 710 using a microwave signal with a frequency of 2.4 GHz, respectively, according to an embodiment of the present disclosure. In the present embodiment, the user inputs a heating condition to heat meat weighing more than 600 grams (i.e., the object to be heated 730), and the corresponding electronic menu indicates the selection of the middle level of the heating chamber 710 as shown in FIG. 7, and instructs the use of the corresponding carrier 732. Herein, the frequency of microwave signal is 2.4 GHz, and the corresponding carrier 732 is equipped with the resonators 740 having resonance frequency of 2.4 GHz, wherein the resonators 740 are placed in an area where the power loss density is relatively weak when the object 730 is heated by microwave signal without the resonators 740. FIG. 8 shows the temperature distribution after 500 seconds of heating with and without resonators for the embodiment in FIG. 7. As shown in FIG. 8, compared to the case without the resonators 740, the temperature difference of microwave heating with the resonators 740 decreases by 5.2 degrees, and the temperature uniformity increases by 6.2%. Obviously, the resonators 740 of the present embodiment improve the heating uniformity of the microwave heating device 700 in heating the object to be heated 730.

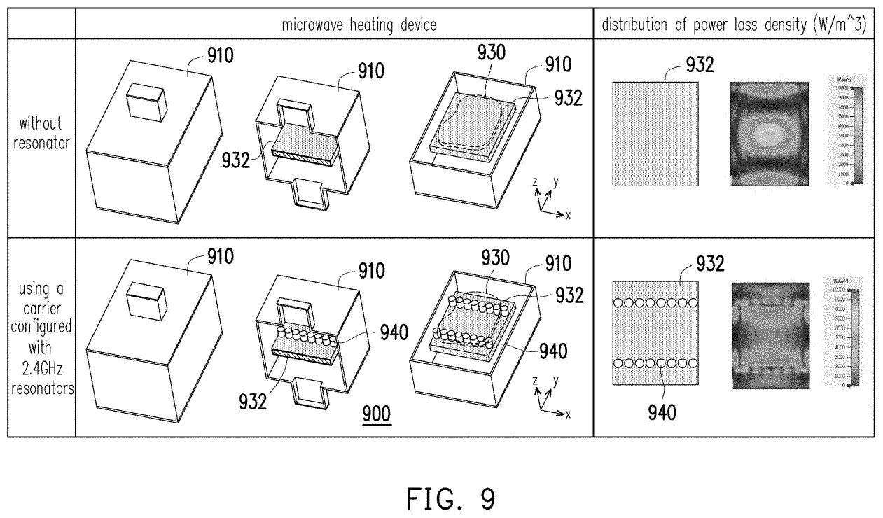

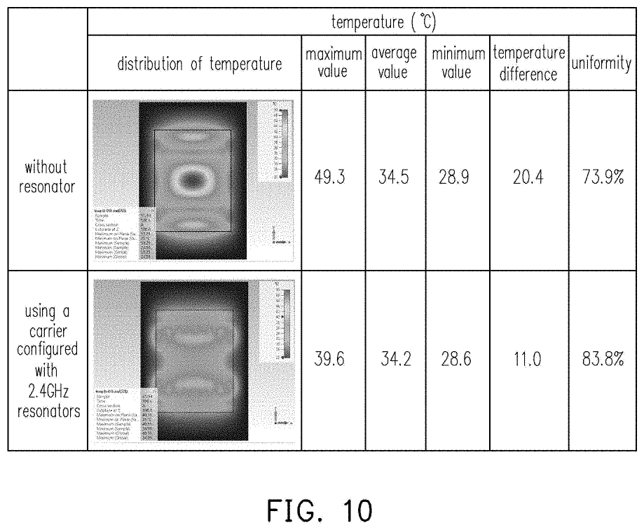

FIG. 9 shows the measurements of the power loss density of the central cross section of the object to be heated 930 with and without the resonators 940 in the heating chamber 910 using a microwave signal with a frequency of 2.4 GHz, respectively, according to an embodiment of the present disclosure. In the present embodiment, the user inputs a heating condition to heat meat weighing about 400 to 500 grams (i.e., the object to be heated 930), and the corresponding electronic menu indicates the selection of the middle level of the heating chamber 910 as shown in FIG. 9, and instructs the use of the corresponding carrier 932. Herein, the frequency of microwave signal is 2.4 GHz, and the corresponding carrier 932 is equipped with the resonators 940 having resonance frequency of 2.4 GHz, wherein the resonators 940 are placed in an area where the power loss density is relatively weak when the object 930 is heated by microwave signal without the resonators 940. FIG. 10 shows the temperature distribution after 500 seconds of heating with and without resonators for the embodiment in FIG. 9. As shown in FIG. 10, compared to the case without the resonators 940, the temperature difference of microwave heating with the resonators 940 decreases by 9.4 degrees, and the temperature uniformity increases by 9.9%. Obviously, the resonators 940 of the present embodiment improve the heating uniformity of the microwave heating device 900 in heating the object to be heated 930.

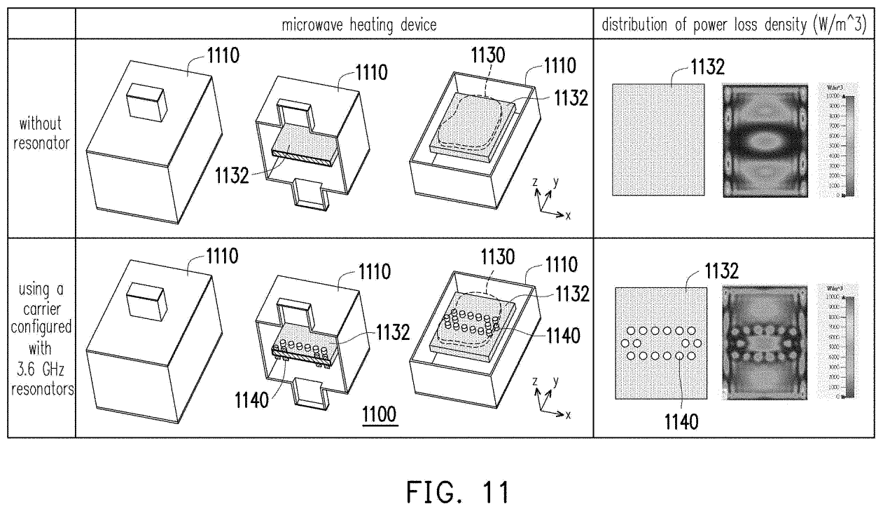

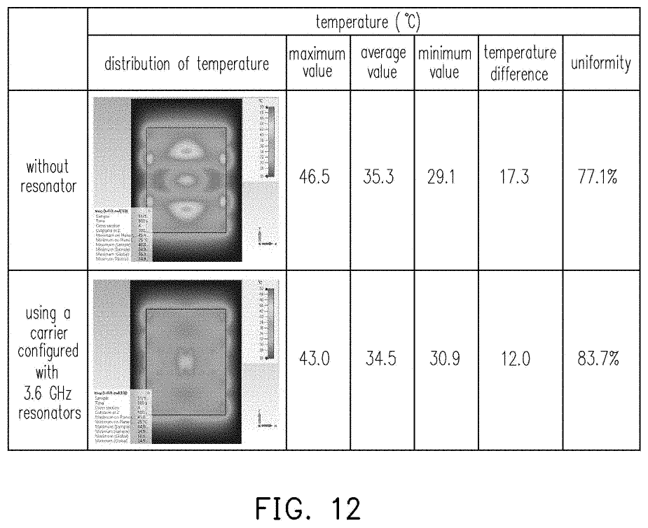

FIG. 11 shows the measurements of the power loss density of the central cross section of the object to be heated 1130 with and without the resonators 1140 in the heating chamber 1110 using a microwave signal with a frequency of 3.6 GHz, respectively, according to an embodiment of the present disclosure. In the present embodiment, the user inputs a heating condition to heat meat weighing more than 600 grams (i.e., the object to be heated 1130), and the corresponding electronic menu indicates the selection of the middle level of the heating chamber 1110 as shown in FIG. 11, and instructs the use of the corresponding carrier 1132. Herein, the frequency of microwave signal is 3.6 GHz, and the corresponding carrier 1132 is equipped with the resonators 1140 having resonance frequency of 3.6 GHz, wherein the resonators 1140 are placed in an area where the power loss density is relatively weak when the object 1130 is heated by microwave signal without the resonators 1140. FIG. 12 shows the temperature distribution after 500 seconds of heating with and without resonators for the embodiment in FIG. 11. As shown in FIG. 12, compared to the case without the resonators 1140, the temperature difference of microwave heating with the resonators 1140 decreases by 5.3 degrees, and the temperature uniformity increases by 6.6%. Obviously, the resonators 1140 of the present embodiment improve the heating uniformity of the microwave heating device 1100 in heating the object to be heated 1130.

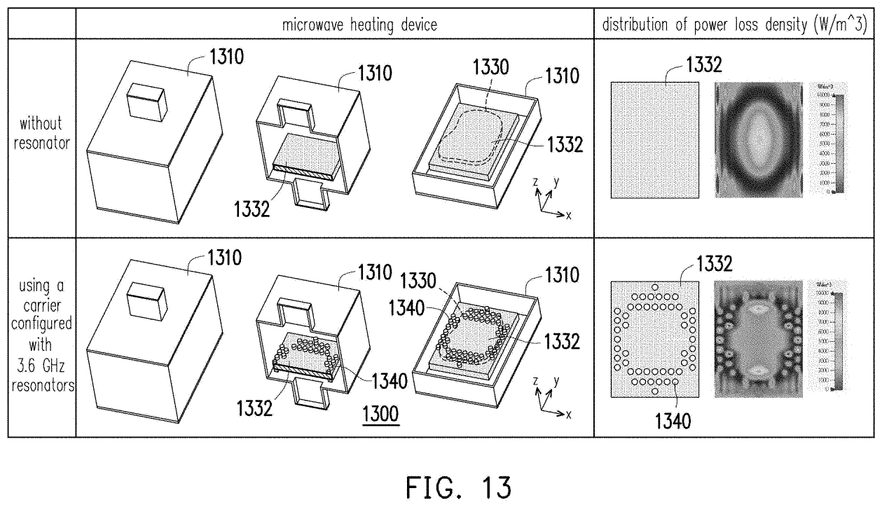

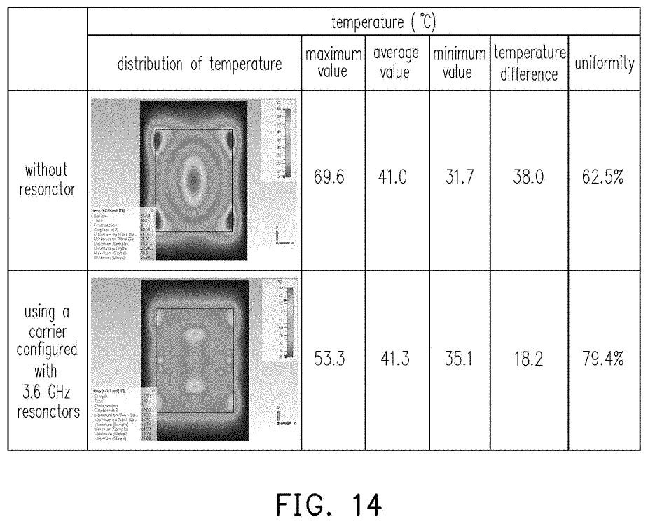

FIG. 13 shows the measurements of the power loss density of the central cross section of the object to be heated 1330 with and without the resonators 1340 in the heating chamber 1310 using a microwave signal with a frequency of 3.6 GHz, respectively, according to an embodiment of the present disclosure. In the present embodiment, the user inputs a heating condition to heat meat weighing about 200 to 400 grams (i.e., the object to be heated 1330), and the corresponding electronic menu indicates the selection of the low level of the heating chamber 1310 as shown in FIG. 13, and instructs the use of the corresponding carrier 1332. Herein, the frequency of microwave signal is 3.6 GHz, and the corresponding carrier 1332 is equipped with the resonators 1340 having resonance frequency of 3.6 GHz, wherein the resonators 1340 are placed in an area where the power loss density is relatively weak when the object 1330 is heated by microwave signal without the resonators 1340. FIG. 14 shows the temperature distribution after 500 seconds of heating with and without resonators for the embodiment in FIG. 13. As shown in FIG. 14, compared to the case without the resonators 1340, the temperature difference of microwave heating with the resonators 1340 decreases by 19.8 degrees, and the temperature uniformity increases by 16.9%. Obviously, the resonators 1340 of the present embodiment improve the heating uniformity of the microwave heating device 1300 in heating the object to be heated 1330.

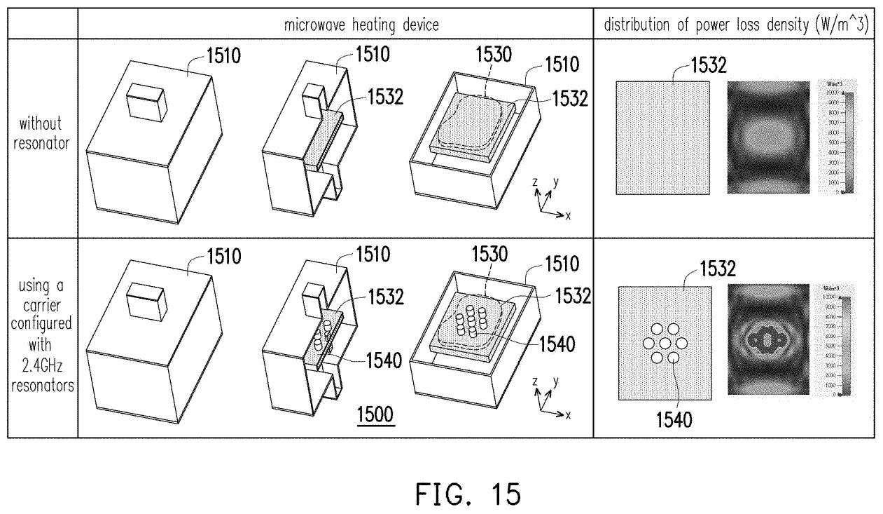

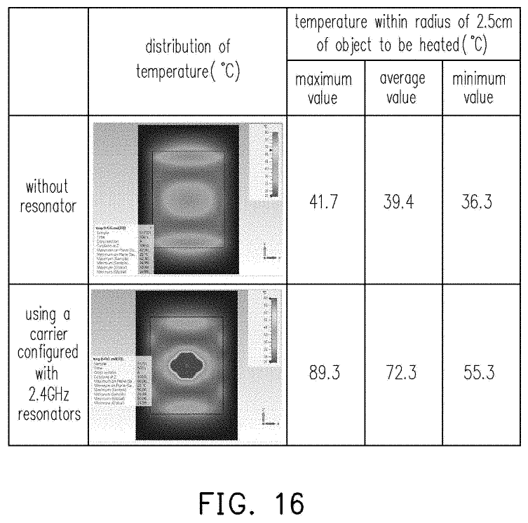

FIG. 15 shows the measurements of the power loss density of the central cross section of the object to be heated 1530 with and without the resonators 1540 in the heating chamber 1510 using a microwave signal with a frequency of 2.4 GHz, respectively, according to an embodiment of the present disclosure. In the present embodiment, the user inputs a heating condition to heat meat weighing about 300 grams (i.e., the object to be heated 1530), and the corresponding electronic menu indicates the selection of concentrated heating mode, placing the object to be heated 1530 in the center of the carrier 1532 and placing the carrier 1532 in the middle level of the heating chamber 1510. Herein, the frequency of microwave signal is 2.4 GHz, and the corresponding carrier 1532 is equipped with the resonators 1540 having resonance frequency of 2.4 GHz, wherein the resonators 1540 are centrally placed in the center area of the carrier 1532. FIG. 16 shows the temperature distribution after 500 seconds of heating with and without resonators for the embodiment in FIG. 15. As shown in FIG. 16, compared to the case without the resonators 1540, the average temperature in the 2.5 cm radius area increased by 32.9 degrees with the center of the object to be heated 1530 as the reference point. Obviously, the resonators 1540 of the present embodiment can increase the heating power of a specific area and achieve the effect of concentrated heating.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A microwave heating method, comprising:
setting a plurality of microwave heating modes and their corresponding resonator layouts;
selecting a microwave heating mode according to a heating condition; and
placing an object to be heated together with at least one resonator in a heating chamber, and providing a microwave signal in the heating chamber to heat the object to be heated, wherein a resonance frequency of the at least one resonator responds to a frequency of the microwave signal, and the at least one resonator is arranged as the resonator layout corresponding to the selected microwave heating mode.

2. The microwave heating method according to claim 1, wherein the method of setting the resonator layout comprises:
obtaining a power loss density in the heating chamber when the object is heated by the microwave signal without placing the at least one resonator; and
determining a position of the at least one resonator according to the power loss density in the heating chamber.

3. The microwave heating method according to claim 1, wherein at least two microwave heating modes provide microwave signals of different frequencies.

4. The microwave heating method according to claim 1, wherein the resonators of at least two microwave heating modes are respectively placed in different positions.

5. The microwave heating method according to claim 1, wherein the resonators of at least two microwave heating modes are respectively placed outside the object to be heated.

6. The microwave heating method according to claim 1, wherein the heating condition comprises at least one of weight of the object to be heated, material of the object to be heated, or state of the object to be heated after being heated.

7. The microwave heating method according to claim 1, wherein each of the microwave heating modes uses a carrier to carry the object to be heated, and each carrier is configured with the at least one resonator.

8. The microwave heating method according to claim 7, wherein the carriers of at least two microwave heating modes are respectively placed in different positions in the heating chamber.

9. A microwave heating device, comprising:
a heating chamber;
a microwave transmitter for providing a microwave to the heating chamber;
a memory circuit, storing multiple microwave heating modes and their corresponding resonator layouts;
at least one resonator, placed in the heating chamber according to the resonator layout corresponding to each microwave heating mode, and a resonance frequency of the at least one resonator responds to a frequency of the microwave signal; and
a processor, electrically connected to the memory circuit and the microwave transmitter, wherein the processor selects a microwave heating mode according to an input heating condition and control the microwave transmitter according to the microwave heating mode, while heating an object to be heated in the corresponding resonator layout.

10. The microwave heating device according to claim 9, further comprising a carrier for carrying the object to be heated, and the carrier is configured with the at least one resonator.

11. The microwave heating device according to claim 10, wherein the at least one resonator is concentrated in the center region of the carrier.

12. The microwave heating device according to claim 10, wherein the at least one resonator comprises a plurality of resonators, which are dispersed on the carrier.
